(19) United States
(12) Patent Application Publication
(10) Pub. No.: US 2008/0285888 A1
(43) Pub. Date: Nov. 20, 2008

(54) IMAGE RESIZING DEVICE AND PARAMETER ADJUSTING METHOD THEREOF

(76) Inventors: Yang-Hung Shih, Hsinchu City (TW); Tang-Hung Po, Pingtung County (TW)

Correspondence Address: NORTH AMERICA INTELLECTUAL PROPERTY CORPORATION, P.O. BOX 506, MERRIFIELD, VA, 22116, US

(21) Appl. No.: 11/749,141

(22) Filed: May 15, 2007

(51) Int. Cl. G06K 9/32

(52) U.S. Cl. 382/300

(57) ABSTRACT

A parameter adjusting method of an image resizing module. The method includes receiving an image signal; and referencing a signal characteristic of the image signal to adjust a parameter with which the image resizing module resizes the image signal.

### BACKGROUND

The present invention relates to an image resizing device, and more particularly, to an image resizing device and a parameter adjusting method thereof.

In image processing, an image resizing device or resizing engine is commonly used to scale or so called resize an image signal when the dimension of an image signal is not appropriate for an output device (e.g. a TV screen or computer display). The image resizing device typically utilizes an interpolation algorithm to resize the image signal, such as linear interpolation, bilinear interpolation, cubic interpolation, or others. The behavior of the interpolation algorithm implemented in the image resizing device can be set or altered by varying one or more parameter used for resizing the image signal. In most cases, selection of the parameter is critical to output quality of the image signal after resizing.

Conventionally, the parameter of the image resizing device is preset to a fixed value and not changeable when resizing the image signal, which may induce unacceptable output quality for some parts of the image signal.

### SUMMARY

An objective of the present invention is to provide an image resizing device and a parameter adjusting method thereof.

An embodiment of a parameter adjusting method of an image resizing module comprises receiving an image signal; and referencing a signal characteristic of the image signal to adjust a parameter with which the image resizing module resizes the image signal.

An embodiment of an image resizing device comprises a signal receiving module, for receiving an image signal; an image resizing module, coupled to the signal receiving module; and a parameter adjusting module, coupled between the signal receiving module and the image resizing module, for referencing a signal characteristic of the image signal to adjust a parameter of the image resizing module; wherein the image resizing module utilizes the adjusted parameter to resize the image signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image resizing device according to an embodiment of the present invention.

FIG. 2 is a flowchart illustrating a parameter adjusting method of an image resizing module according to an embodiment of the present invention.

FIG. 3 is a schematic diagram illustrating an embodiment of an image resizing module in FIG. 1.

FIG. 4 is a schematic diagram illustrating cubic horizontal interpolation performed by an image resizing module in FIG. 3 and a related cubic convolution function.

FIG. 5 is a flowchart illustrating details of the referencing step of the method in FIG. 2.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

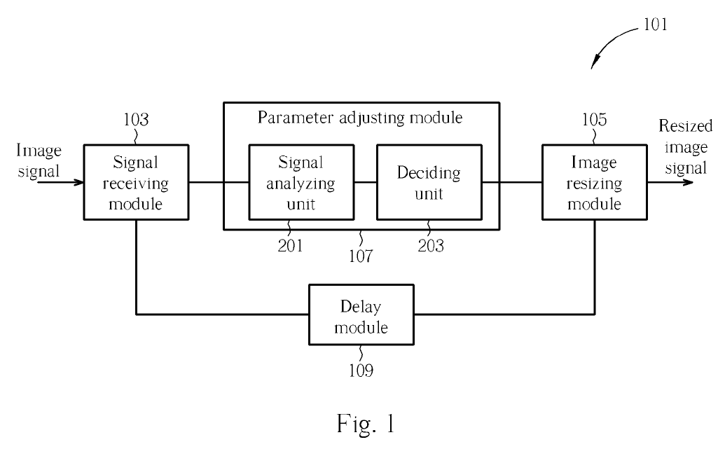

FIG. 1 is a block diagram illustrating an image resizing device 101 according to an embodiment of the present invention. As shown in FIG. 1, the image resizing device 101 comprises a signal receiving module 103, an image resizing module 105, a parameter adjusting module 107, and a delay module 109. The parameter adjusting module 107 is coupled between the signal receiving module 103 and the image resizing module 105. The delay module 109 is also coupled between the signal receiving module 103 and the image resizing module 105. Moreover, the parameter adjusting module 107 comprises a signal analyzing unit 201 and a deciding unit 203.

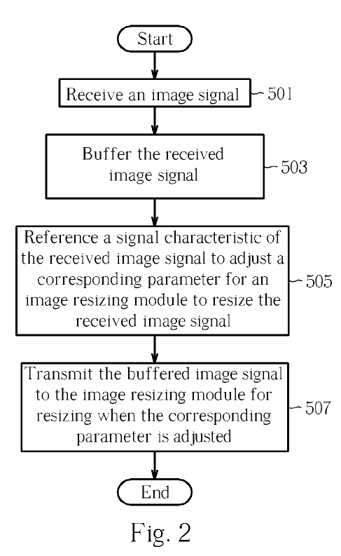

FIG. 2 is a flowchart illustrating an embodiment of a parameter adjusting method for the image resizing module 101 shown in FIG. 1. As shown in FIG. 2, the method comprises the following steps:
STEP 501: Receive an image signal;
STEP 503: Buffer the received image signal;
STEP 505: Reference a signal characteristic of the received image signal to adjust a corresponding parameter for an image resizing module to resize the received image signal; and
STEP 507: Transmit the buffered image signal to the image resizing module for resizing when the corresponding parameter is adjusted.

The detailed description as to how the image resizing device 101 in FIG. 1 applies the parameter adjusting method in FIG. 2 is as follows.

Please refer to FIGS. 1 and 2. The signal receiving module 103 receives an image signal (STEP 501). The image signal in the present invention comprises any form or format of image signals applicable. For example, the image signal can be a continuous signal or a discrete signal. Moreover, the term “image signal” should be interpreted to include images, image data, data signals containing images, or any other image-related term applicable. In the present invention, the image signal may comprise a specific length of signal belonging to an analog image signal, or some number of values (e.g. pixel values) in a digital image signal. The delay module 109 buffers the received image signal until a corresponding parameter of the image resizing module is adjusted (STEP 503). Specifically, buffering duration for buffering the received image signal in the delay module 109 corresponds actual time utilized for determining and adjusting the corresponding parameter by the parameter adjusting module 107. In some embodiments of the present invention, the delay module 109 may buffer the received image signal for one or a plurality of operating clock cycles, scan lines, or frames. Additionally, buffering duration for buffering the received image signal in the delay module 109 can be determined by the amount of information in the received image signal required to be referenced in the parameter adjusting module 107. The parameter adjusting module 107 references a signal characteristic of the received image signal to adjust one or more parameter utilized by the image resizing module 105 for resizing the received image signal (STEP 505).

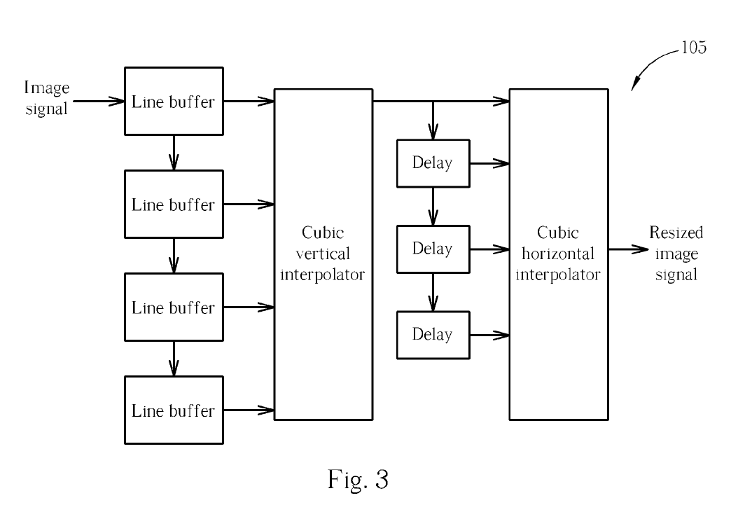

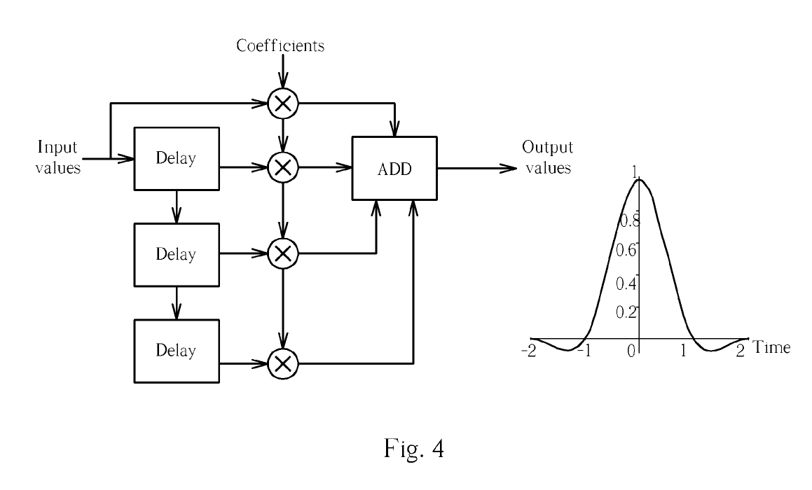

In one embodiment, the parameter corresponds to a set of coefficients of an algorithm utilized by the image resizing module 105 for resizing the image signal, where the algorithm may correspond to vertical interpolation, horizontal interpolation, or both vertical and horizontal interpolations. Please refer to FIG. 3. FIG. 3 is a schematic diagram illustrating an embodiment of the image resizing module 105 in FIG. 1. As shown, the image resizing module 105 comprises a 4-taps cubic interpolation filter performing vertical and horizontal interpolation on the image signal for resizing the image signal. Since the principles behind the cubic vertical interpolation and the cubic horizontal interpolation are similar, only the cubic horizontal interpolation is explained hereafter for understanding. Please refer to FIG. 4. FIG. 4 is a schematic diagram illustrating cubic horizontal interpolation performed by the image resizing module 105 in FIG. 3 and a related cubic convolution function. In this embodiment, the image resizing module 105 (i.e. the 4-taps cubic interpolation filter) requires 4 pixels to perform the horizontal interpolation. Suppose in the received image signal, 4 consecutive pixels on a horizontal line are referred to as first pixel, second pixel, third pixel, and fourth pixel respectively, and a target pixel is required to be inserted between the second pixel and the third pixel by the image resizing module 105. In such a case, the image resizing module 105 can utilize values of the first, second, third, and fourth pixels to build a cubic convolution function (as shown in FIG. 4) corresponding to the following equations:

C₁=at³−2at²+at;

C₂=(a+2)t³−(a+3)t²+1;

C₃=−(a+2)t³+(2a+3)t²−at; and

C₄=−at³+at²,

wherein C₁ to C₄ are coefficients of the algorithm corresponding to the cubic horizontal interpolation, a is an adjustable parameter, and t is a value on a temporal axis. Additionally, the coefficients C₁, C2, C₃, and C₄ correspond to the first, second, third, and fourth pixels respectively. The value t corresponds to a fractional distance from the second pixel to the target pixel on a temporal axis. In this embodiment, a is the parameter controlled by the parameter adjusting module based on the signal characteristic. It is obvious from the above equations that the adjustable parameter a affects the set of coefficients C₁ to C₄ of the algorithm. Since the 4-taps cubic interpolation filter is well known to the skilled in the art, the details of implementing cubic horizontal interpolation with respect to the above equations are thus omitted for simplicity. Please note that, in the prior art, this parameter a is preset to a fixed value, for example −0.5, and not changeable when resizing the image signal. In this embodiment, however, a can be dynamically adjusted to an appropriate value suitable for the currently received image signal to be resized by the image resizing module 105. Please note that although a is regarded as the parameter in this embodiment, the parameter adjusted based on the signal characteristic in other embodiments could be any parameter which has influence on the characteristic of the image resizing module 105, for example, a parameter corresponding to a sampling phase, a quantity of taps, or a sharp value of the image resizing module 105. The sampling phase corresponds to a time interval between a target pixel and an existing pixel on a temporal axis, wherein the target pixel is the pixel to be inserted into a specific position near the existing pixel in the image signal. Adjusting the sampling phase thus means performing some time shift when calculating the value of the target pixel. After calculation, the value of the target pixel is recorded correspondingly to the specific position, thereby completing inserting of the target pixel into the specific position. These examples are not meant to be a limitation of the present invention, however.

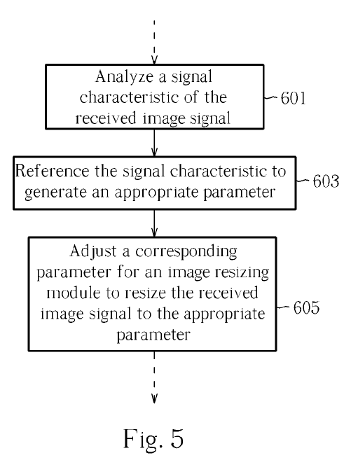

Additionally, in one embodiment of the present invention, STEP 505 further comprises more steps. FIG. 5 is a flowchart showing details of the referencing step 505 of the method in FIG. 2. As shown in FIG. 5, the referencing step 505 comprises the following steps:
STEP 601: Analyze a signal characteristic of the received image signal;
STEP 603: Reference the signal characteristic to generate an appropriate parameter; and
STEP 605: Adjust a corresponding parameter for an image resizing module to resize the received image signal to the appropriate parameter.

Please refer to FIGS. 1 and 5. The signal analyzing unit 201 first analyzes a signal characteristic of the received image signal (STEP 601). The deciding unit 203 then references the signal characteristic to generate an appropriate parameter for the image resizing module 105 (STEP 603), so that the corresponding parameter can be adjusted to the appropriate parameter, wherein the corresponding parameter is utilized by the image resizing module 105 for resizing the received image signal (STEP 605).

In one embodiment of the present invention, the signal characteristic may correspond to a frequency characteristic of the received image signal, and the signal analyzing unit 201 may utilize a pixel window to analyze the frequency characteristic of the received image signal. The pixel window may contain some number of pixels (e.g. 4 pixels) near a desired position of a target pixel on a specific horizontal line, a specific vertical line, or in a specific area, wherein the target pixel is the pixel required to be inserted into the desired position in the received image signal.

In another embodiment, the signal characteristic may correspond to an edge characteristic of the received image signal, and the signal analyzing unit 201 may calculate a difference value between two adjacent pixels in the received image signal to generate, for example, a total value containing all difference values between any two adjacent pixels on a specific horizontal line in a pixel window. In such a case, a larger total value implies greater variation of the received image signal, or implies that the received image signal contains more details.

Yet in another embodiment, if the signal characteristic corresponds to a frequency characteristic of the received image signal, the signal analyzing unit 201 may comprise a filter bank selected from the group consisting of high pass filters (HPFs), band pass filters (BPFs), and low pass filters (LPFs) for analyzing the frequency characteristic of the received image signal. For example, the signal analyzing unit 201 may comprises only one HPF. In another example, the signal analyzing unit 201 may comprises a HPF and a BPF, respectively having a set of tap coefficients {−1, 2, −1} and {−1 0 2 0 −1}, and the signal analyzing unit 201 thus utilizes these two filters to analyze the frequency band of the image signal. In such a case, the deciding unit 203 references values output from the HPF and the BPF to generate the appropriate parameter. For example, if the value output from the HPF is greater than a first threshold, and the value output from the BPF is less than a second threshold, the image signal will be determined as an image signal in a high frequency band, and thus the deciding unit 203 will generate a parameter suitable for a high frequency band signal as the appropriate parameter. These examples are not meant to be a limitation of the present invention, however. Please note that after understanding the principles of the present invention, those skilled in the art can easily determine values of the first threshold and the second threshold for the corresponding pixel windows. Additionally, the decision logic of the deciding unit 203 as described above can be implemented by hardware (e.g. circuitry) or software (e.g., firmware stored in a storing unit).

Some embodiments of the deciding unit 203 may utilize a look-up table to generate the appropriate parameter, and the look-up table is predetermined according to sufficient experimental results. For example, the look-up table may prerecord a plurality of pairs of analyzing results and appropriate parameters for future reference.

Please return to FIGS. 1 and 2. Following STEP 605, the delay module 109 transmits the buffered image signal to the image resizing module 105 after the corresponding parameter of the image resizing module 105 is adjusted (STEP 507). The parameter adjusting method ends at this point. Additionally, with the parameter adjusting method as described above, the image resizing module 105 can utilize the adjusted parameter to resize the image signal transmitted from the delay module 109 and thus output a resized image signal as shown in FIG. 1. In one embodiment of the present invention, the image resizing module 105 utilizes the adjusted parameter to perform a vertical interpolation, a horizontal interpolation, or both on the image signal, thereby completing resizing the image signal. This is not meant to be a limitation of the present invention, however.

Some embodiments of the image resizing device 101 may adjust the parameter used to resize a current frame according to the signal characteristic retrieved from the current frame, or may adjust the parameter used to resize the current frame according to the signal characteristic retrieved from a previous frame. Some other embodiments of the image resizing device 101 may reference the signal characteristic of more than one frame to determine the parameter.

Please note that although the signal receiving module 103, the image resizing module 105, the parameter adjusting module 107, and the delay module 109 are shown in FIG. 1 as individual hardware components, this is not meant to be a limitation of the present invention. For example, the functionality of the parameter adjusting module 107 can be implemented by hardware (e.g. circuitry) or software (e.g., firmware stored in a storing unit). In another example, the parameter adjusting module 107 can be integrated into the image resizing module 105, and the image resizing module 105 thus takes charge of the functionality of the parameter adjusting module 107 as described above. Please note that these alternative designs all fall in the scope of the present invention.

In the present invention, a parameter utilized for resizing an image signal by an image resizing module can be properly adjusted according to a signal characteristic (such as frequencies, edges, or others) of the image signal before the image resizing module actually utilizes the parameter to resize the image signal. In other words, the parameter can be dynamically adjusted to an appropriate parameter suitable for resizing each portion of the image signal, thereby improving output quality of the resized image signal. For example, the parameter is dynamically adjusted to resize the image signal according to its frequency band. Simply speaking, the parameter in the image resizing module of the present invention is adaptive to the content of the image signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A parameter adjusting method of an image resizing module, comprising:
receiving an image signal; and
referencing a signal characteristic of the image signal to adjust a parameter with which the image resizing module resizes the image signal.

2. The method of claim 1, wherein the signal characteristic corresponds to a frequency characteristic or an edge characteristic of the image signal.

3. The method of claim 1, wherein the parameter corresponds to a sampling phase, a quantity of taps, or a sharp value of the image resizing module.

4. The method of claim 1, wherein the parameter corresponds to a set of coefficients of an algorithm utilized by the image resizing module to resize the image signal.

5. The method of claim 1, wherein the parameter is utilized by the image resizing module to perform a vertical interpolation, a horizontal interpolation, or both on the image signal.

6. The method of claim 1, further comprising:
buffering the received image signal until the corresponding parameter is adjusted; and
transmitting the buffered image signal to the image resizing module after the corresponding parameter is adjusted.

7. The method of claim 6, wherein buffering the received image signal until the corresponding parameter is adjusted comprises buffering the received image signal for one or a plurality of operating clock cycles, scan lines, or frames until the corresponding parameter is adjusted.

8. The method of claim 1, wherein referencing the signal characteristic of the image signal to adjust the parameter with which the image resizing module resizes the image signal comprises:
analyzing the signal characteristic of the image signal;
referencing the signal characteristic to generate an appropriate parameter; and
adjusting the parameter with which the image resizing module resizes the image signal to the appropriate parameter.

9. The method of claim 8, wherein the signal characteristic corresponds to a frequency characteristic of the image signal, and analyzing the signal characteristic of the image signal is performed by a filter bank selected from the group consisting of high pass filters (HPFs), band pass filters (BPFs), and low pass filters (LPFs).

10. The method of claim 8, wherein the signal characteristic corresponds to a frequency characteristic of the image signal, and analyzing the signal characteristic of the image signal comprises utilizing a pixel window to analyze the frequency characteristic of the image signal.

11. The method of claim 8, wherein the signal characteristic corresponds to an edge characteristic of the image signal, and analyzing the signal characteristic of the image signal comprises calculating a difference value between two adjacent pixels in the image signal.

12. An image resizing device, comprising:
a signal receiving module, for receiving an image signal;
an image resizing module, coupled to the signal receiving module; and
a parameter adjusting module, coupled between the signal receiving module and the image resizing module, for referencing a signal characteristic of the image signal to adjust a parameter of the image resizing module;
wherein the image resizing module utilizes the adjusted parameter to resize the image signal.

13. The device of claim 12, wherein the signal characteristic corresponds to a frequency characteristic or an edge characteristic of the image signal.

14. The device of claim 12, wherein the parameter corresponds to a sampling phase, a quantity of taps, or a sharp value of the image resizing module.

15. The device of claim 12, wherein the parameter corresponds to a set of coefficients of an algorithm utilized by the image resizing module to resize the image signal.

16. The device of claim 12, wherein the adjusted parameter is utilized by the image resizing module to perform a vertical interpolation, a horizontal interpolation, or both on the image signal.

17. The device of claim 12, wherein the image resizing module is a cubic interpolation filter.

18. The device of claim 12, further comprising:
a delay module, coupled between the signal receiving module and the image resizing module, for buffering the received image signal until the corresponding parameter is adjusted, and transmitting the buffered image signal to the image resizing module after the corresponding parameter is adjusted.

19. The device of claim 18, wherein the delay module buffers the received image signal for one or a plurality of operating clock cycles, scan lines, or frames until the corresponding parameter is adjusted.

20. The device of claim 12, wherein the parameter adjusting module comprises:
a signal analyzing unit, coupled to the signal receiving module, for analyzing the signal characteristic of the image signal; and
a deciding unit, coupled to the signal analyzing unit and the image resizing module, for referencing the signal characteristic to generate an appropriate parameter and adjusting the parameter with which the image resizing module resizes the image signal to the appropriate parameter.

21. The device of claim 20, wherein the signal characteristic corresponds to a frequency characteristic of the image signal, and the signal analyzing unit comprises a filter bank selected from the group consisting of high pass filters (HPFs), band pass filters (BPFs), and low pass filters (LPFs) for analyzing the frequency characteristic of the image signal.

22. The device of claim 20, wherein the signal characteristic corresponds to a frequency characteristic of the image signal, and the signal analyzing unit utilizes a pixel window to analyze the frequency characteristic of the image signal.

23. The device of claim 20, wherein the signal characteristic corresponds to an edge characteristic of the image signal, and the signal analyzing unit calculates a difference value between two adjacent pixels in the image signal.
